(19) United States
(12) Patent Application Publication
(10) Pub. No.: US 2009/0038762 A1
(43) Pub. Date: Feb. 12, 2009

(54) CORD FIXER FOR VENETIAN BLIND

(76) Inventor: Chia Ching HSIEH, Taichung (TW)

Correspondence Address: SINORICA, LLC, 528 FALLSGROVE DRIVE, ROCKVILLE, MD, 20850, US

(21) Appl. No.: 11/835,605

(22) Filed: Aug. 8, 2007

(51) Int. Cl. E06B 9/32

(52) U.S. Cl. 160/168.1 R

(57) ABSTRACT

A cord fixer for venetian blind includes a headrail, a bottomrail, a plurality of slats, and a plurality of lift cords extending from the headrail to the slats and terminating at bottomrail. At least one cord fixer applied for receipt of the lift cords and thusly, securing the lift cords within the corresponding bottomrail. The cord fixer has an upper surface facing to the slat and a bottom surface facing to the bottomrail, at least one fitting member being positioned on the bottom surface allowing the lift cords to wrap around. And a fitting groove is constructed at the end of the fitting member for receipt of the lift cords. Conveniently, one can flexibly adjust the position of the corresponding rails and lift cord length in accordance to the actual blind size by means of lift cords and fitting members. Without engaging a knot-making process during the blind assembly, the present invention has proven to further reduce overall cost of the manufacturing and assembling process of venetian blinds.

### BACKGROUND OF THE INVENTION

1. Field of the Invention

This instant invention relates to a cord fixer for venetian blind and, more particularly, to a plate for easily securing a lift cord to a bottomrail and yet being able to adjust the lift cord length and the relative position of the bottomrail.

2. Description of the Prior Art

A traditional horizontal blind generally has a headrail, a plurality of slats, a bottomrail, and a lift cord penetrates through the slats from the headrail extending downwardly to the bottomrail and out through the underside bore of a cord fixer inserted within the bottomrail and, subsequently entangling a knot at a proper position on the lift cord, such knot of the lift cord is comparatively bigger than the diameter of the bore of the cord fixer so as to fasten the lift cord upon the cord fixer.

To achieve better adjustability of the lift cord length in relation to the cord fixer, U.S. Pat. Nos. 6,119,757 and 6,302,183 both disclose a cord fixer for a horizontal blind, in which the bottomrail has an opening at a corresponding position to the lift cord, and a snug-fitted type of cord fixer fastened in the opening. The lift cord is entangled into a knot at its free end after passing through the opening of the cord fixer, and then the cord fixer is fitted tightly within the predetermined position in the bottomrail, so that the lift cord is stably fastened upon the cord fixer in the bottomrail. The U.S. Pat. No. 6,463,985 to Pey-Son the lift cord passes through the bottomrail and out of the cord fixer, the free end of the lift cord is fastened into a knot for securing purpose. In addition, the U.S. Pat. Nos. 6,948,216, 6,845,801, 5,769,143, 5,518,057, 4,886,102 and 4,621,673 disclose alternate types of cord fixers in varying structures for horizontal blinds so as to acquire effortless assembly process.

However, horizontal blinds generally have varying specifications, so workers at assembly lines have to substantially adjust both the lift cord length and the position of the associated rails according to a specific blind size, so as to obtain great extent on light blockage and aesthetic appearance of the blind. As mentioned previously, the prior art is commonly seen and designed utilizing the knot entangled at the free end of the lift cord for securing the lift cord upon the bottomrail, however, such knot is not easily disentangled and, consequently, the lift cord length is difficult to readjust by means of cord fixer. Accordingly, there is an urgent need in the horizontal blind industry for a cord fixer structure, which readily and quickly secured to the associated rails of a horizontal blind assembly to secure the lower end of the lift cord to the bottommost rail in the manufacturing and assembly process.

### SUMMARY OF THE INVENTION

A cord fixer for a blind according to the instant invention is installed in a bottomrail of a blind that includes a headrail, a plurality of slats provided between the headrail and the bottomrail, plural lift cords extending downwardly from the headrail, through the slats to the bottomrail and then subsequently fastened with at least one cord fixer within the bottomrail. The cord fixers have an upper surface facing to the slats and a bottom surface facing to the bottomrail, allowing the lift cord to pass through. And at least one fitting member is protruded outwardly on the bottom surface of the cord fixer, allowing the lift cord to be securely wound about thereon. Besides, a fitting groove is further provided at end portion of such fitting member for securely receipt of the lift cord therebetween. The cord fixer depicted in the instant invention not only can suspend the bottomrail, but also allow the lift cords to be stably fitted within the fitting groove of the fitting members after wrapping around the fitting members, so the lift cords can be immovably kept by fastening itself in the fitting grooves without entangling the free end of life cord into a knot. Therefore, it has proven to provide an effortless and user-friendly method on the extent of adjustability of lift cord length and rails positions during assembly and disassembly process in accordance to the actual blind sizes and thusly, reducing the labor time and process necessary to manufacturing a horizontal blind assembly.

### BRIEF DESCRIPTION OF DRAWINGS

This invention will be better understood by referring to the accompanying drawings, wherein:

FIG. 1 is a partial exploded perspective view of a blind with a cord fixer in the present invention;

FIG. 2 is a side view of a bottomrail and the cord fixer combined in the present invention;

FIG. 3 is a perspective view of the cord fixer in the present invention;

FIG. 4 is a perspective view of the cord fixer with a lift cord combined in a first way in the present invention;

FIG. 5 is a perspective view of the cord fixer combined with the lift cord in a second way in the present invention;

FIG. 6 is a perspective view of the cord fixer combined with the lift cord in a third way in the present invention;

FIG. 7 is a perspective view of the cord fixer combined with the lift cord in a fourth way in the present invention;

FIG. 8 is a perspective view of the cord fixer combined with the lift cord in a fifth way in the present invention;

FIG. 9 is a partial exploded perspective view of a second preferred embodiment of a cord fixer for a blind in the present invention;

FIG. 10 is a partial exploded perspective view of a third preferred embodiment of a cord fixer for a blind in the present invention; and

FIG. 11 is a side view of a fourth preferred embodiment of a cord fixer for a blind in the present invention .

### DETAILED DESCRIPTION OF THE PREFERRED EMBODIMENTS

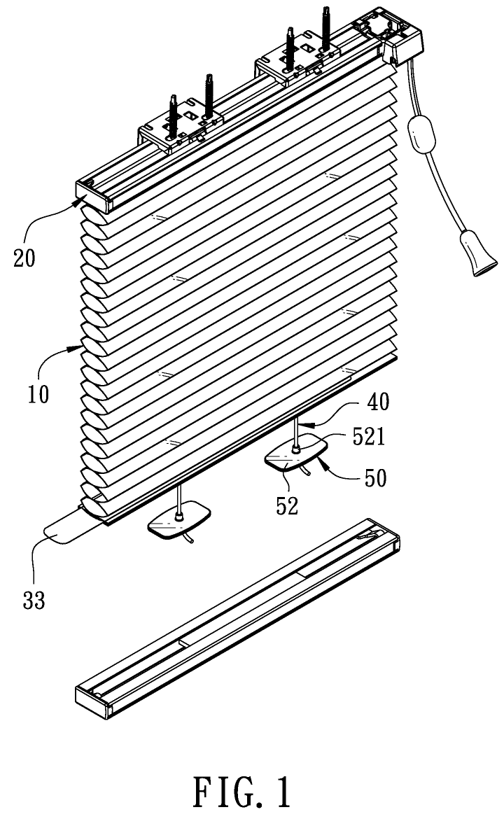

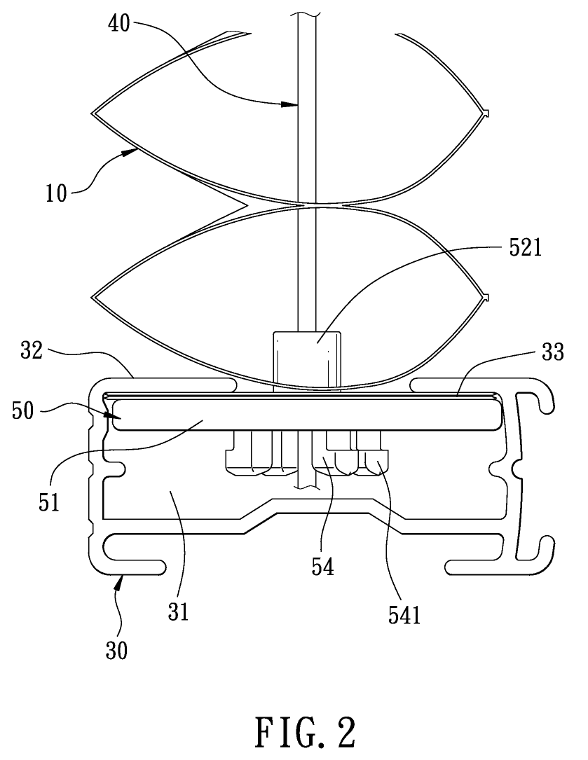

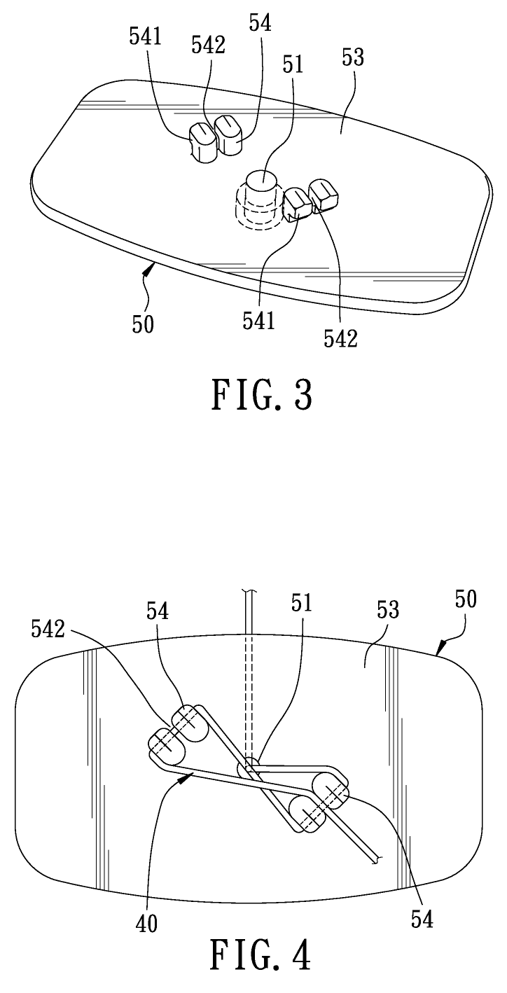

A first preferred embodiment of a cord fixer 50 for a blind in the present invention, referring initially to FIGS. 1-3, is combined with a blind, which includes a plurality of slats 10, a headrail 20, a bottomrail 30, and two lift cords 40 extending downwardly from two sides of the headrail 20 through the slats 10 and reaching the bottomrail 30. The headrail 20 and the bottomrail 30 respectively having a through hole (not shown) for the lift cords 40 to pass through, and the lift cords 40 are respectively fixed stably upon the cord fixer 50 and eventually restored within the corresponding bottomrail 30.

The bottomrail 30 is provided with a lengthwise hollow space 31 with an upper opening along the longitudinal axis, a block member 32 is respectively formed extending from two sides of the upper opening of the hollow space 31, so the cord fixer 50 may be kept within the hollow space 31 and thusly, being restrained in position between the two block members 32. The lowest slat 10 is provided with an insert member 33 at interior for connecting the associated slat 10 with the bottomrail 30 and further securely positioned between the opening of the hollow space 31 and the cord fixer 50. The insert member 33 has a hole (not shown) at a point corresponding to the cord fixer 50 so that the cord fixer 50 is securely restrained in position by the block member 32 with the lift cord 40 passing through such hole (not shown) on the insert member 33. Moreover, the bottomrail 30 is provided with a respective seal cover 34 at two lateral sides.

The cord fixer 50 is a rectangular plate, configured with a central hole 51 having respective longer sides and shorter sides. In this embodiment, the bottomrail width is extensive great in degree, so the cord fixture 50 is inserted with its longer sides mating to the interior of upwardly extending side walls of the bottomrail 30. Further, the cord fixer 50 has an upper surface 52 facing to the lowest slat 10 and a bottom surface 53 facing to the bottomrail 30, the central hole 51 is constructed and arranged to penetrate through the central passage between the upper surface 52 and bottom surface 53 and a cylindrical member 521 is fixed on the upper surface 52, having a shaft hole (not shown) communicating with the central hole 51 for the lift cord 40 to pass through. Further, a fitting member 54 is respectively formed on the bottom surface 53 at a proper location corresponding to the opposite side of the central hole 51, which is further provided with a position-limiting block 541 at the end portion of the respective fitting member in parallel relation to the bottom surface 53 so that the lift cord 40 may be wrapped around thereon and stably restrained in position after passing through the central hole 51, and thusly being securely received within one of the fitting grooves 542 formed at end portion of the fitting member 541.

Next, in assembly process, the lift cord 40 is made to pass through the hole (not shown) of the insert member 33 inside the lowest slat 10, then out of the central hole 51 of the cord fixer 50, properly wound around the fitting member 54 and subsequently received within the fitting groove 542. Referring to FIG. 4, a first wrapping method for such lift cords is shown. After the lift cord 40 is extended through the central hole 51 of the cord fixer 50 and directed to wind around the periphery of the right fitting member 54 then redirected to wind around the periphery of the left fitting member 54 located at diagonal orientation, the free end of the lift cord 40 is eventually received within the fitting groove 542 locating between the right fitting members 54, forming a figure eight-like twisting. Finally the lengthwise sides of the cord fixer 50 are inserted through the lateral (short) side of the bottomrail 30 into the hollow space 31 to complete the assembly process. Therefore, the lift cord 40 can be readily disassembled from and reassembled to the cord fixer 50 according to the varying blind sizes so that the length of the lift cord 40 may be subsequently adjusted.

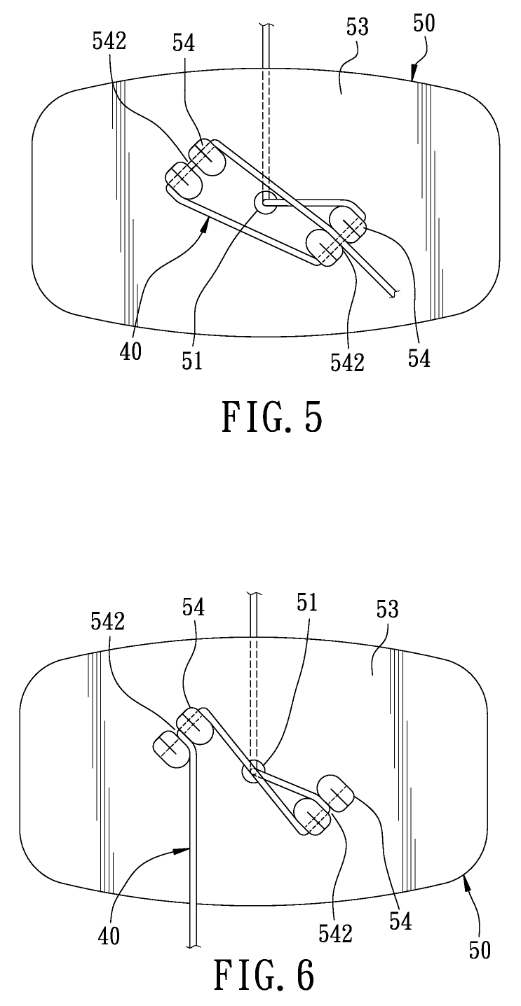

Referring to FIG. 5, another lift cord wrapping method is shown, wherein the lift cord 40 is made to extend out of the central hole 51 of the cord fixer 50 first, then travels towards the right fitting member 54 and being wound around the outer side of the right fitting member 54, then travels to the left fitting member 54 and being wound around the periphery of the left fitting member 54, and the free end of the lift cord 40 is then fitted tightly within the fitting groove 542 of the right fitting member 54.

Referring to FIG. 6, yet a third lift cord wrapping method is depicted, wherein the lift cord 40 is made to extend through the central hole 51 of the cord fixer 50 first, then to be fitted within the fitting groove 542 of the right fitting member 54, and subsequently disposed along the outer rim portion of abutting fitting member 54 to redirect itself to the periphery of the left fitting member 54 at diagonal orientation, and eventually fitted within the fitting groove 542 locating between the left fitting members 54.

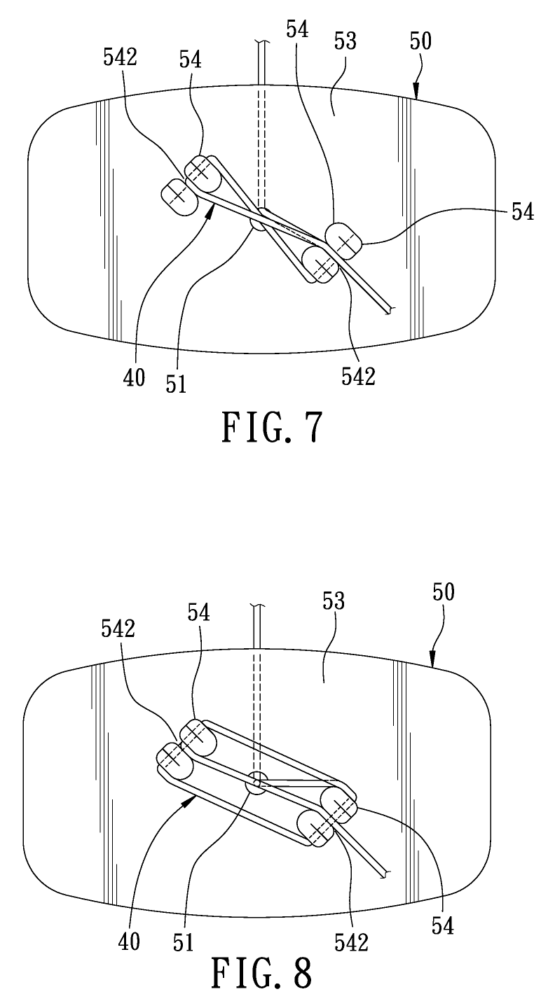

Referring to FIG. 7, a fourth lift cord wrapping method is shown, wherein after the lift cord 40 is made to extend through the central hole 51 of the cord fixer 50 first, then the lift cord 40 being disposed around the periphery of the right fitting member 54 and redirected to the periphery of the left fitting member 54 and finally fastened within the fitting groove 542 of the right fitting member 54.

FIG. 8 shows a fifth way of arranging the lift cord 40, wherein after the lift cord 40 is arranged to extend through the central hole 51 of the cord fixer 50 first, the lift cord 40 being disposed around the periphery of the right fitting member 54 at one side then directed to the opposite side of the right fitting member 54, making at least one loop to form a concentric circle thereon and finally fitting tightly within the fitting groove 542 of the left or the right fitting member 54.

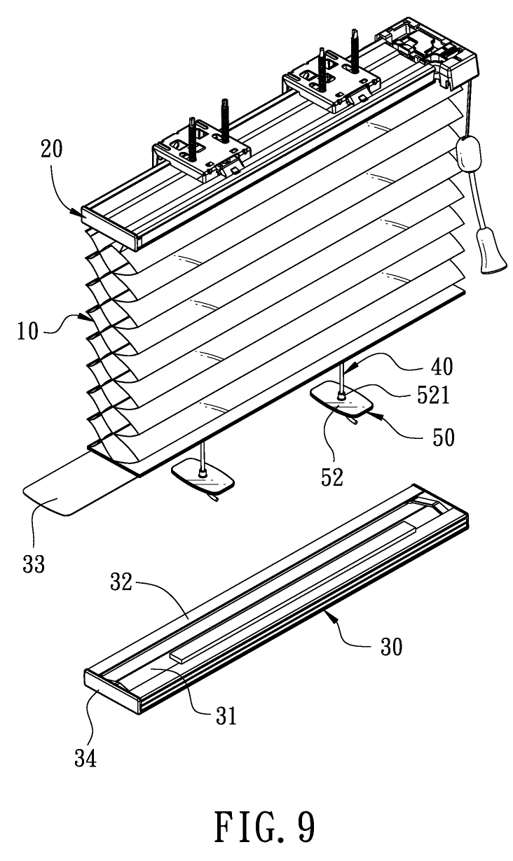

Next, referring to FIG. 9 shows a second preferred embodiment with a partially dismantled blind which has resembled structure to the blind used in the first embodiment, except that the width of the bottomrail 30 is comparatively narrower, while assembling, one has to insert the shorter sides of the cord fixer 50 to mate with the interior of two upwardly extending side walls of the bottomrail 30.

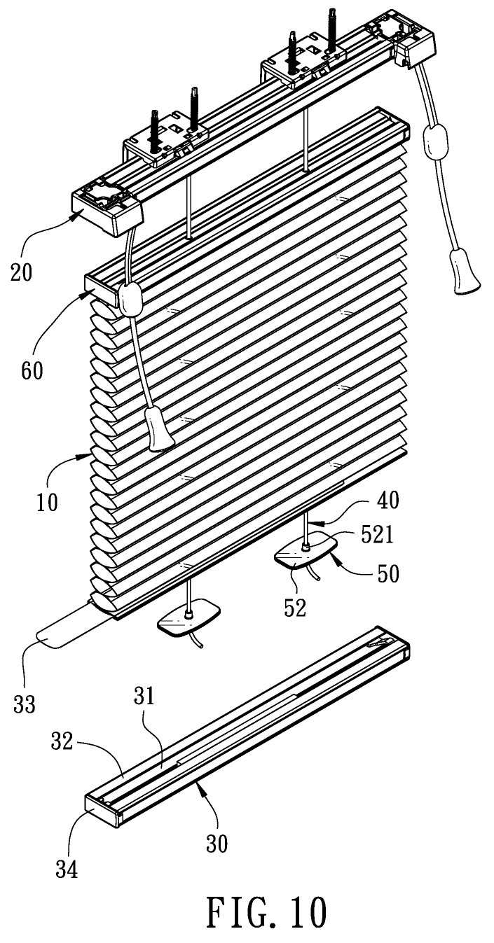

FIG. 10 shows a third preferred embodiment of a blind, which is almost resembled to the structure of the first embodiment, except that the blind has three rails namely, a headrail 20, a middle rail 60 and a bottomrail 30, with a cord fixer 50 being installed within the middle rail 60 and the bottomrail 30.

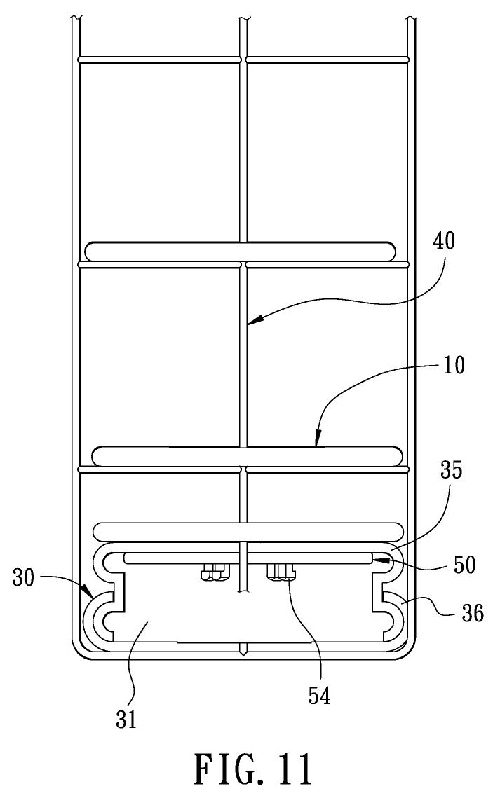

Moreover, FIG. 11 shows a cross-sectional view of another embodiment of the bottomrail 30 combined with the cord fixer 50, the structure and effect of both components are almost resembled to aforesaid embodiments except the bottomrail 30 now is composed of an upper cover 35 with a downwardly extending opening and a lower cover 36 with an upwardly extending opening, with the upper cover 35 slidably positioned at interior of two upwardly extending side walls of the lower cover 36 along the longitudinal axis so as to form a hollow space 31 therein between the upper cover 35 and the lower cover 36.

In addition, the width of the fitting groove 542 of the cord fixer 50 is designed to have relatively smaller extent than the diameter of the lift cord 40, so the lift cord 40 will not become slacking and subsequently slip away from the fitting groove 542 once being secured therein. Consequently, while one attempts to replace the slats 10 or perform the slats 10 cut downs, the blind can be readily dismantled and reassembled with the rearrangement of the lift cord 40 and yet flexibly adjust both the positions of the lift cord 40 and the associated rails, thereby, effectively reducing the time and tedious step of fastening the free end of the lift cord 40 to the associated rails.

The instant invention offers the following advantages:

1. By means of fitting members of the cord fixer, the lift cord can be properly wrapped around the associated fitting members first and then securely fastened within one of the fitting grooves without the independent step of entangling the free end of the lift cord into a knot. The cord fixer of the present invention configured with simple design providing an effortless way to flexibly adjust and fasten the lift cord to the associated rails by interacting action between the lift cords and corresponding fitting members.

2. The cord fixer of the instant invention is designed to releasably fasten with the lift cord, so it can be flexibly positioned along the lift cord in accordance to the practical usage and thereby, the bottomrail position can be quickly readjusted, ensuring the blind length to fully coordinate with the actual window frame specifications.

While the preferred embodiment of the invention has been described above, it will be recognized and understood that various modifications may be made therein and the appended claims are intended to cover all such modifications that may fall within the spirit and scope of the invention.

What is claimed is:

1. A cord fixer for venetian blind, said blind including a headrail, a bottomrail, a plurality of slats installed therebetween the headrail and the bottomrail, a plurality of lift cords extending downwardly from the headrail through the slats to the bottomrail, wherein the respective headrail and the bottomrail having at least a bore for the lift cords to pass through, and at least a cord fixer releasably fitted within the corresponding bottomrail for stably fixing the lift cords therein; and
the cord fixer respectively having an upper surface facing toward a slat side and a bottom surface facing to the bottomrail, and a central hole is formed thereon penetrating through the upper surface and terminating at the bottom surface, allowing the lift cords to pass through, and at least a projected fitting member structured and disposed in the bottom surface for fixly winding the lift cords thereon, a fitting groove provided at end portion of the fitting member for receipt of the lift cords therein.

2. The cord fixer for venetian blind as claimed in claim 1, wherein the cord fixer is provided with a dimensionally cylindrical member on the upper surface, and the cylindrical member is constructed with a through hole communicating with the central hole for passage of the lift cords therethrough.

3. The cord fixer for venetian blind as claimed in claim 1, wherein the fitting groove extends from an end portion of the fitting member and further penetrates to the upper surface of the cord fixer.

4. The cord fixer for venetian blind as claimed in claim 1, wherein a position-limiting block is further provided, extending in a parallel relation to the bottom surface along the end portion of the fitting member.

5. The cord fixer for venetian blind as claimed in claim 1, wherein the cord fixer is configured into a rectangular shape.

6. The cord fixer for venetian blind as claimed in claim 1, wherein said bottomrail is provided with a lengthwise hollow space with an upper opening at a longitudinal axis for receipt of the cord fixer, and a block member is further provided at two lengthwise sides of the upper opening of the hollow space of the bottomrail for releasably restraining the position of the cord fixer.

7. The cord fixer for venetian blind as claimed in claim 1, wherein the fitting groove has a relative smaller width comparatively to a lift cord diameter.

8. A cord fixer for venetian blind, said blind including at least three rails, a plurality of slats positioned between two adjacent rails of the three rails and a plurality of lift cords extending downwardly from a headrail through the slats, the respective three rails having at least a bore for the passage of the lift cords, and at least a cord fixer releasably fitted in corresponding bottomrail for securing the lift cords therein; and
the cord fixer respectively having an upper surface facing toward a slat side and a bottom surface facing to the bottomrail, and a central hole is formed thereon extending downwardly from the upper surface and penetrating to the bottom surface, allowing the lift cords to pass through, and at least a projected fitting member structured and disposed in the bottom surface for tightly winding the lift cords thereon, a fitting groove provided at end portion of the fitting member for receipt of the lift cords therein.

9. The cord fixer for venetian blind as claimed in claim 8, wherein the cord fixer is provided with a dimensionally cylindrical member on the upper surface, and the cylindrical member is constructed with a through hole communicating with the central hole for passage of the lift cords therethrough.

10. The cord fixer for venetian blind as claimed in claim 8, wherein the fitting groove extends from an end portion of the fitting member and further penetrates to the upper surface of the cord fixer.

11. The cord fixer for venetian blind as claimed in claim 8, wherein a position-limiting block is further provided, extending in a parallel relation to the bottom surface along the end portion of the fitting member.

12. The cord fixer for venetian blind as claimed in claim 8, wherein the cord fixer is configured into a rectangular shape.

13. The cord fixer for venetian blind as claimed in claim 8, wherein said bottomrail is provided with a lengthwise hollow space with an upper opening at a longitudinal axis for receipt of the cord fixer, and a block member is further provided at two lengthwise sides of the upper opening of the hollow space of the bottomrail for releasably restraining a position of the cord fixer therein.

14. The cord fixer for venetian blind as claimed in claim 8, wherein the fitting groove has a relative smaller width comparatively to a lift cord diameter.
